(19) United States
(12) Patent Application Publication
(10) Pub. No.: US 2023/0369869 A1
(43) Pub. Date: Nov. 16, 2023

(54) Mobile Charging Station

(71) Applicant: Motivo Engineering, LLC, Gardena, CA (US)

(72) Inventors: Damon Pipenberg, Torrance, CA (US); Xavier Kevin Dedenbach, Los Angeles, CA (US); Maximilian Fredrick Ballenger Sluiter, Oak Park, CA (US); Stephan J. R. Schmitz-Justen, Torrance (CA); Corey A. Williams, SR., Lakewood, CA (US)

(21) Appl. No.: 17/743,017

(22) Filed: May 12, 2022

(51) Int. Cl. H02J 7/00; B60L 53/18; B60L 53/51; B60L 53/53

(52) U.S. Cl. CPC H02J 7/0013; B60L 53/18; B60L 53/51; B60L 53/53; H02J 7/0047

(57) ABSTRACT

An apparatus and methods are provided for a mobile charging station for simultaneously charging multiple electrically powered vehicles. The mobile charging station comprises a trailer housing rechargeable batteries and multiple fast-charge ports disposed on the trailer for servicing the electrically powered vehicles. The mobile charging station can be coupled to a truck and moved to any suitable location for charging the electrically powered vehicles. The onboard rechargeable batteries can be recharged with electrical energy from an electrical grid, a solar array, or by way of equipment stored onboard the trailer. Each fast-charge port includes a charging cable for routing electricity to an electrically powered vehicle to be recharged. A connector comprising each charging cable is configured to be plugged into a charging port of the electrically powered vehicle. Each charging cable is supported by an elastic cable mounted to the trailer above the charge port.

### FIELD

Embodiments of the present disclosure generally relate to the field of powered vehicles. More specifically, embodiments of the disclosure relate to an apparatus and methods for a mobile charging station for recharging multiple electric vehicles.

### BACKGROUND

Electrically powered vehicles generally solve problems associated with gasoline-powered vehicles, such as environmental pollution, noise and depletion of crude oil reserves due to the increasing use of gasoline-powered vehicles. As such, electrically powered vehicles are gaining in popularity and their use is becoming increasingly widespread. Unfortunately, a fast-charge infrastructure is failing to meet the increasing demands posed by an ever-increasing number of electric vehicles on the roads. For example, establishing a stationary fast-charging station tends to be a lengthy process. In many instances, acquiring the necessary permits to start construction of a fast-charging site can take up to two years.

Given the increasing prevalence of electric vehicles of all types, there is a continuing interest in providing a fast-charging infrastructure that is capable of meeting the demands of a growing national fleet of electrically powered vehicles.

### SUMMARY

An apparatus and methods are provided for a mobile charging station for simultaneously charging multiple electrically powered vehicles. The mobile charging station comprises a trailer housing rechargeable batteries and multiple fast-charge ports disposed on the trailer for servicing the electrically powered vehicles. The mobile charging station can be coupled to a truck and moved to any suitable location for charging the electrically powered vehicles. The onboard rechargeable batteries can be recharged with electrical energy from an electrical grid, a solar array, or by way of equipment stored onboard the trailer. Each fast-charge port includes a charging cable for routing electricity to an electrically powered vehicle to be recharged. A connector comprising each charging cable is configured to be plugged into a charging port of the electrically powered vehicle. Each charging cable is supported by an elastic cable mounted to the trailer above the charge port.

In an exemplary embodiment, a mobile charging station for charging batteries onboard multiple electrically powered vehicles comprises: a trailer housing a multiplicity of rechargeable batteries; multiple charge ports disposed on the trailer and powered by the multiplicity of batteries; a charging cable comprising each of the multiple charge ports for routing to each electrically powered vehicle; a connector comprising each charging cable and configured to be plugged into a charging port of the electrically powered vehicle; and an elastic cable for supporting at least a portion of the weight of the charging cable.

In another exemplary embodiment, the trailer comprises a 19-foot long truck trailer that is configured to service five electrically powered vehicles. In another exemplary embodiment, the trailer houses about 2,500 or more lead-acid batteries for charging the electrically powered vehicles.

In another exemplary embodiment, the rechargeable batteries can be recharged with electrical energy from an electrical grid or a solar array. In another exemplary embodiment, the rechargeable batteries can be recharged by way of charging equipment stored onboard the trailer. In another exemplary embodiment, the equipment comprises as solar panels disposed on a roof of the trailer. In another exemplary embodiment, the equipment is configured to charges the rechargeable batteries while the trailer is being towed by a truck. In another exemplary embodiment, the equipment comprises an onboard electric generator configured to recharge the batteries when needed.

In another exemplary embodiment, each of the charge ports comprises a fast-charging system capable of providing about 220 Volts. In another exemplary embodiment, the elastic cable is coupled by way of a mount or mechanism disposed on the trailer above each charge port. In another exemplary embodiment, each charge port includes LEDs that are configured to indicate information pertaining to charging the electrically powered vehicle.

In an exemplary embodiment, a method for a mobile charging station for charging batteries onboard multiple electrically powered vehicles comprises: providing a trailer configured to be towed by a truck; housing a multiplicity of rechargeable batteries within the trailer; installing multiple charge ports on the trailer; powering the multiple charge ports by way of the multiplicity of rechargeable batteries; and supporting a charging cable comprising each of the multiple charge ports by way of an elastic cable.

In another exemplary embodiment, providing the trailer comprises providing a 19-foot long truck trailer that is configured to service five electrically powered vehicles. In another exemplary embodiment, housing the multiplicity of rechargeable batteries includes housing about 2,500 or more lead-acid batteries inside the trailer.

In another exemplary embodiment, installing the multiple charge ports includes configuring each of the multiple charge ports to be a fast-charging system capable of providing about 220 Volts. In another exemplary embodiment, installing the multiple charge ports includes configuring LEDs comprising each charge port to indicate information pertaining to charging the electrically powered vehicle. In another exemplary embodiment, supporting the charging cable includes coupling the elastic cable by way of a mount or mechanism disposed on the trailer above each charge port.

In another exemplary embodiment, housing the multiplicity of rechargeable batteries includes configuring the multiplicity of rechargeable batteries to be recharged with electrical energy from an electrical grid or a solar array. In another exemplary embodiment, housing the multiplicity of rechargeable batteries includes configuring the multiplicity of rechargeable batteries to be recharged by way of charging equipment stored onboard the trailer.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a schematic diagram of an exemplary embodiment of a mobile charging station servicing multiple electric vehicles, according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the mobile charging station and methods disclosed herein may be practiced without these specific details. In other instances, specific numeric references such as “first charger,” may be made. However, the specific numeric reference should not be interpreted as a literal sequential order but rather interpreted that the “first charger” is different than a “second charger.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Electrically powered vehicles generally solve problems associated with gasoline-powered vehicles, such as environmental pollution, noise and depletion of crude oil reserves due to the increasing use of gasoline-powered vehicles. As such, electrically powered vehicles are gaining in popularity and their use is becoming increasingly widespread. Unfortunately, a fast-charge infrastructure is failing to meet the increasing demands posed by an ever-increasing number of electric vehicles on the roads. Given the increasing prevalence of electric vehicles of all types, there is a continuing interest in providing a fast-charging infrastructure that is capable of meeting the demands of a growing national fleet of electrically powered vehicles. Embodiments disclosed herein relate to a mobile charging station that can be implemented more quickly than stationary charging stations that require a lengthy permitting process.

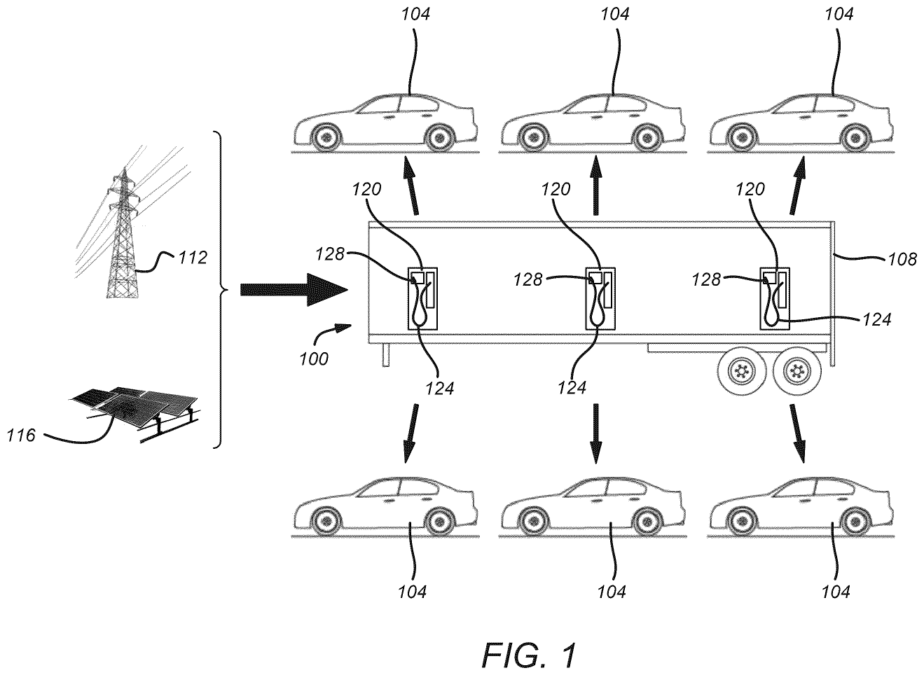

FIG. 1 illustrates a schematic diagram of an exemplary embodiment of a mobile charging station 100 servicing multiple electrically powered vehicles 104, according to the present disclosure. The mobile charging station 100 is configured to charge batteries onboard each of the electrically powered vehicle 104. In some embodiments, the mobile charging station 100 is configured to simultaneously charge five or more vehicles 104. Further, the electrically powered vehicles 104 are not limited to automobiles, as illustrated in FIG. 1, but rather the mobile charging station 100 can be used to charge any of various types of electrically powered vehicles, such as watercraft, aircraft, motorcycles, electrically powered bicycles, scooters, and the like, without limitation.

The mobile charging station 100 generally comprises a trailer 108 that houses a multiplicity of rechargeable batteries (not shown) for charging the vehicles 104. As such, the trailer 108 can be coupled with a truck and then moved to any suitable location for charging the vehicles 104. In some embodiments, multiple trailers 108 may be parked together at the same site and combined to provide a portable fast-charging station capable of servicing large numbers of vehicles 104, as needed. It is contemplated that such a portable fast-charging station may comprise an electric analog of a traditional service station that provides gasoline and diesel to internal combustion fueled vehicles. As such, each of the vehicles 104 may be charged for the quantity of electric charge received from the mobile charging station 100. Further, the portability of the trailer 108 facilitates leasing the mobile charging station 100 to third party vendors, as desired.

Moreover, the portability of the mobile charging station 100 provides an additional benefit of obviating any need for a permitting process that is typically required before beginning construction of a new stationary fast-charging station. As such, it is envisioned that the mobile charging station 100 can be implemented to provide a fast-charging infrastructure that is capable of meeting the demands of a growing national fleet of electrically powered vehicles.

In one exemplary embodiment, the trailer 108 comprises a 19-foot long truck trailer that is configured to service five electrically powered vehicles, such as the vehicles 104. In such a five port system, the trailer 108 may house about 2,500 or more lead-acid batteries for charging the vehicles 104. As indicated in FIG. 1, the batteries comprising the mobile charging station 100 can be supplied or recharged with electrical energy from an electrical grid 112 or a solar array 116. In some embodiments, the batteries may be recharged by way of charging equipment stored onboard the trailer 108. In some embodiments, for example, the solar array 116 may be incorporated into the structure of the trailer 108, such as solar panels disposed on a roof of the trailer 108. In other embodiments, the trailer 108 may include equipment that charges the batteries while the trailer 108 is being towed by a truck. In still other embodiments, the trailer 108 may include an electric generator configured to recharge the batteries when needed.

As shown in FIG. 1, the mobile charging station 100 generally includes multiple fast-charge ports 120. Each fast-charge port 120 is configured to service one of the vehicles 104. To this end, each fast-charge port 120 includes a charging cable 124 that may be routed from the fast-charge port 120 to the vehicle 104 to be charged. Each of the charging cables 124 includes a connector 128 configured to be plugged into a charging port of each vehicle 104.

As will be appreciated, fast-charging systems capable of providing 220 Volts require relatively heavy charging cables 124. Thus, each charge port 120 may include an elastic cable (not shown) that supports at least a portion of the weight of the charging cable 124. It is contemplated that the elastic cable may be coupled with a mount or a mechanism disposed on the trailer 108 above each fast-charge port 120. It is further contemplated that each fast-charge port 120 may include LEDs that are configured to display information pertaining to charging the vehicle 104, such as charging rate, charge status of the battery of the vehicle 104, total charge transferred to the battery of the vehicle 104, total cost of transferred charge, and the like, without limitation.

While the mobile charging station and methods have been described in terms of particular variations and illustrative FIGURES, those of ordinary skill in the art will recognize that the mobile charging station is not limited to the variations or FIGURES described. In addition, where methods and steps described above indicate certain events occurring in certain order, those of ordinary skill in the art will recognize that the ordering of certain steps may be modified and that such modifications are in accordance with the variations of the mobile charging station. Additionally, certain of the steps may be performed concurrently in a parallel process when possible, as well as performed sequentially as described above. To the extent there are variations of the mobile charging station, which are within the spirit of the disclosure or equivalent to the mobile charging station found in the claims, it is the intent that this patent will cover those variations as well. Therefore, the present disclosure is to be understood as not limited by the specific embodiments described herein, but only by scope of the appended claims.

What is claimed is:

1. A mobile charging station for charging batteries onboard multiple electrically powered vehicles, comprising:
a trailer housing a multiplicity of rechargeable batteries;
multiple charge ports disposed on the trailer and powered by the multiplicity of batteries;
a charging cable comprising each of the multiple charge ports for routing to each electrically powered vehicle;
a connector comprising each charging cable and configured to be plugged into a charging port of the electrically powered vehicle; and
an elastic cable for supporting at least a portion of the weight of the charging cable.

2. The mobile charging station of claim 1, wherein the trailer comprises a 19-foot long truck trailer that is configured to service five electrically powered vehicles.

3. The mobile charging station of claim 2, wherein the trailer houses about 2,500 or more lead-acid batteries for charging the electrically powered vehicles.

4. The mobile charging station of claim 1, wherein the rechargeable batteries can be recharged with electrical energy from an electrical grid or a solar array.

5. The mobile charging station of claim 1, wherein the rechargeable batteries can be recharged by way of charging equipment stored onboard the trailer.

6. The mobile charging station of claim 5, wherein the equipment comprises as solar panels disposed on a roof of the trailer.

7. The mobile charging station of claim 5, wherein the equipment is configured to charge the rechargeable batteries while the trailer is being towed by a truck.

8. The mobile charging station of claim 5, wherein the equipment comprises an onboard electric generator configured to recharge the batteries when needed.

9. The mobile charging station of claim 1, wherein each of the charge ports comprises a fast-charging system capable of providing about 220 Volts.

10. The mobile charging station of claim 1, wherein the elastic cable is coupled by way of a mount or mechanism disposed on the trailer above each charge port.

11. The mobile charging station of claim 1, wherein each charge port includes LEDs that are configured to indicate information pertaining to charging the electrically powered vehicle.

12. A method for a mobile charging station for charging batteries onboard multiple electrically powered vehicles, comprising:
providing a trailer configured to be towed by a truck;
housing a multiplicity of rechargeable batteries within the trailer;
installing multiple charge ports on the trailer;
powering the multiple charge ports by way of the multiplicity of rechargeable batteries; and
supporting a charging cable comprising each of the multiple charge ports by way of an elastic cable.

13. The method of claim 12, wherein providing the trailer comprises providing a 19-foot long truck trailer that is configured to service five electrically powered vehicles.

14. The method of claim 12, wherein housing the multiplicity of rechargeable batteries includes housing about 2,500 or more lead-acid batteries inside the trailer.

15. The method of claim 12, wherein installing the multiple charge ports includes configuring each of the multiple charge ports to be a fast-charging system capable of providing about 220 Volts.

16. The method of claim 12, wherein installing the multiple charge ports includes configuring LEDs comprising each charge port to indicate information pertaining to charging the electrically powered vehicle.

17. The method of claim 12, wherein supporting the charging cable includes coupling the elastic cable by way of a mount or mechanism disposed on the trailer above each charge port.

18. The method of claim 12, wherein housing the multiplicity of rechargeable batteries includes configuring the multiplicity of rechargeable batteries to be recharged with electrical energy from an electrical grid or a solar array.

19. The method of claim 12, wherein housing the multiplicity of rechargeable batteries includes configuring the multiplicity of rechargeable batteries to be recharged by way of charging equipment stored onboard the trailer.
